(19) United States
(12) Patent Application Publication
(10) Pub. No.: US 2007/0175886 A1
(43) Pub. Date: Aug. 2, 2007

(54) Slow cooker

(75) Inventors: John D. Barnes, Richmond, VA (US); James Gaynor, Richmond, VA (US); David Jackson, Mechanicsville, VA (US); Yvonne Olson, Richmond, VA (US); Guoyao Ye, Richmond, VA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Hamilton Beach/Proctor-Silex, Inc.

(21) Appl. No.: 11/346,095

(22) Filed: Feb. 2, 2006

(51) Int. Cl. F27D 11/00

(52) U.S. Cl. 219/401

(57) ABSTRACT

A slow cooker for heating of food stuffs includes a container having a generally hollow interior and a container rim defining an opening for accessing the interior. The interior is capable of retaining the food stuffs therein. A first base for supporting the container has an electric heating element, which is selectively powered to heat the container and the food stuffs therein. A second base for supporting the container accommodates a flame heater therein for heating the container and the food stuffs therein. The first and second bases are alternatively used to heat the container.

### BACKGROUND OF THE INVENTION

The present invention relates to slow cookers and, in particular, to a slow cooker having more than one base for use therewith.

Typically, slow cookers include only one base, which typically includes some type of electric heating element. While such electric bases are generally common, they require a nearby electrical power source to operate. However, it is not always possible to have a power source close to the desired location for use of the slow cooker, such as when using the slow cooker outdoors, for instance. There are also occasions when it would be undesirable to have a visible electrical cord extending between the slow cooker and the power source. Therefore, it would be desirable to have a slow cooker that has the capability to be used to heat food stuffs with or without electrical power.

### BRIEF SUMMARY OF THE INVENTION

Briefly stated, the present invention is a slow cooker for heating of food stuffs. The slow cooker comprises a container having a generally hollow interior and a container rim defining an opening for accessing the interior. The interior is capable of retaining the food stuffs therein. A first base for supporting the container has an electric heating element, which is selectively powered to heat the container and the food stuffs therein. A second base for supporting the container accommodates a flame heater therein for heating the container and the food stuffs therein. The first and second bases are alternatively used to heat the container.

### BRIEF DESCRIPTION OF THE SEVERAL VIEWS OF THE DRAWINGS

The foregoing summary, as well as the following detailed description of a preferred embodiment of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawing:

FIG. 1 is a front elevational view of a slow cooker in accordance with a preferred embodiment of the present invention, a container being seated upon a first base of the slow cooker;

FIG. 2 is a front elevational view of the slow cooker of FIG. 1, the container being seated upon a second base of the slow cooker;

FIG. 3 is an exploded perspective view of the slow cooker of FIGS. 1 and 2;

FIG. 4 is a front perspective view of the first base of the slow cooker of FIG. 1; and

FIG. 5 is a front perspective view of the second base of the slow cooker of FIG. 2.

### DETAILED DESCRIPTION OF THE INVENTION

Certain terminology is used in the following description for convenience only and is not limiting. The words “right”, “left”, “upper”, and “lower” designate directions in the drawings to which reference is made. The terminology includes the words above specifically mentioned, derivatives thereof, and words of similar import.

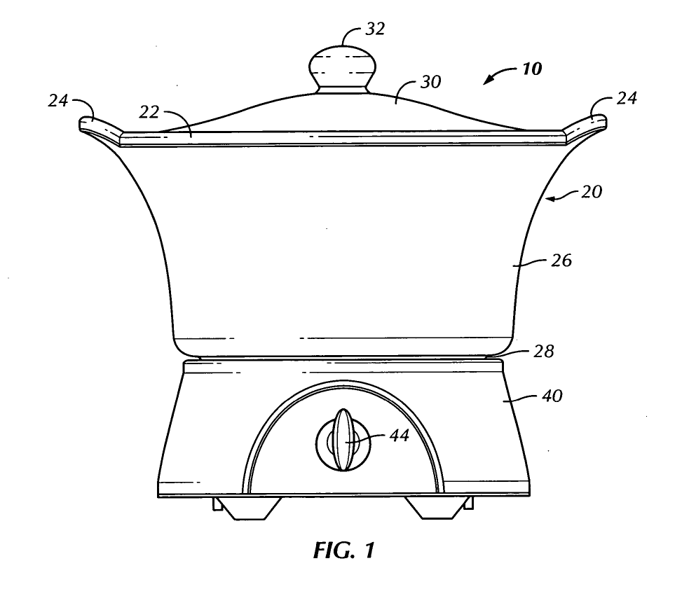

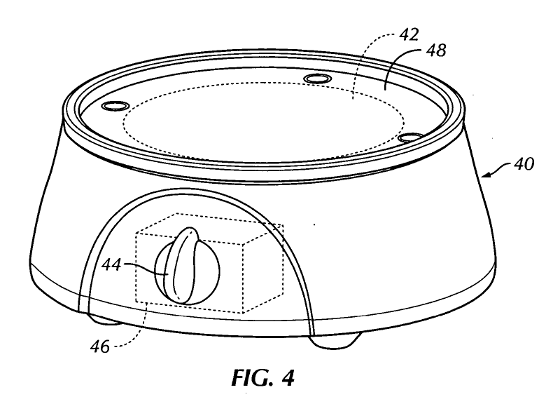

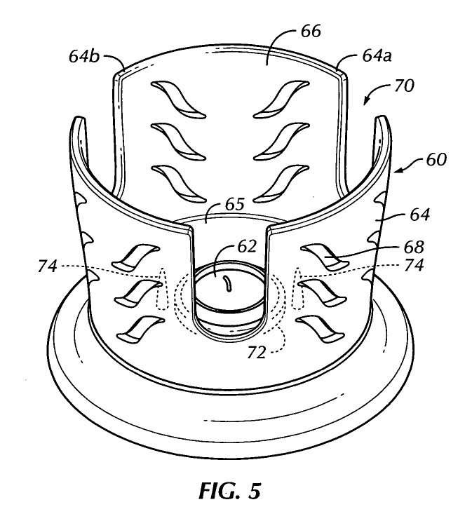

Referring to the drawings in detail, wherein like numerals indicate like elements throughout, there is shown in FIGS. 1-5 a preferred embodiment of a slow cooker, indicated generally at 10, for warming and/or cooking, collectively referred to as heating, of food stuffs (not shown).

Referring to FIGS. 1-3, the slow cooker 10 includes a container 20 having a generally cylindrical shape and preferably being made of stoneware. The container 20 is generally similar to known slow cooker containers, except that the container 20 is preferably generally smaller than a “normal” slow cooker container. The container 20 is intended to hold smaller portions of food stuffs, such as appetizers or other smaller serving dishes, for instance, although this is not intended to be limiting. As such, it is within the spirit and scope of the present invention that the container 20 be of any size for accommodating any amount of food stuffs therein. Additionally, it should be apparent to those skilled in the art that a material other than stoneware can be used, such as ceramic, glass, or metal, for instance, provided the container 20 is still capable of functioning to retain food stuffs therein and withstand heat. Lastly, it should be understood that while a generally cylindrical container 20 is described and portrayed herein, the container 20 can be of any shape, provided it can function as described herein.

The container 20 has a generally hollow interior 20a for retaining food stuffs within the container 20 in order to heat, store, and/or serve the food stuffs therein. The container 20 includes a bottom wall 28, which is preferably generally circular in plan view. Extending generally upwardly from the bottom wall 28 is a generally cylindrical side wall 26, terminating at a container rim 22, which defines an opening 22a for accessing the interior 20a of the container 20. In this way, the interior 20a of the container 20 is defined by the side wall 26 and the bottom wall 28. Preferably, the container 20 has a pair of diametrically opposed handles 24 extending outwardly from the container 20 for picking up and otherwise handling the container 20. Preferably, the handles 24 are at least generally proximate the rim 22 and, more preferably, extend outwardly from the rim 22.

The slow cooker 10 further includes a lid 30 removably mounted on the container rim 22. Preferably, the lid 30 is sized and shaped to at least partially close the opening 22a of the container 20 when placed on the rim 22 thereof. Preferably, the lid 30 is generally circular in plan view and is sized to totally close the opening 22a of the container 20, thereby completely enclosing the hollow interior 20a in order to facilitate the heating of food stuffs within the container 20. The lid 30 preferably includes a handle 32 extending from a top surface thereof to enable the lid 30 to be picked up or otherwise moved by a user. While a small, knob-like handle 32 is portrayed, it is within the spirit and scope of the present invention that the handle be differently configured provided it is still capable of functioning as described herein. Preferably, like the container 20, the lid 30 is made of stoneware, although it is within the spirit and scope of the present invention that the lid 30 be made of another material, such as ceramic, glass, or metal. While it is preferred that the lid 30 be made of the same material as the container 20, it is further within the spirit and scope of the present invention that the lid 30 be made of a different material from that of the container 20, provided the lid 30 still functions to at least partially enclose the interior 20a of the container 20.

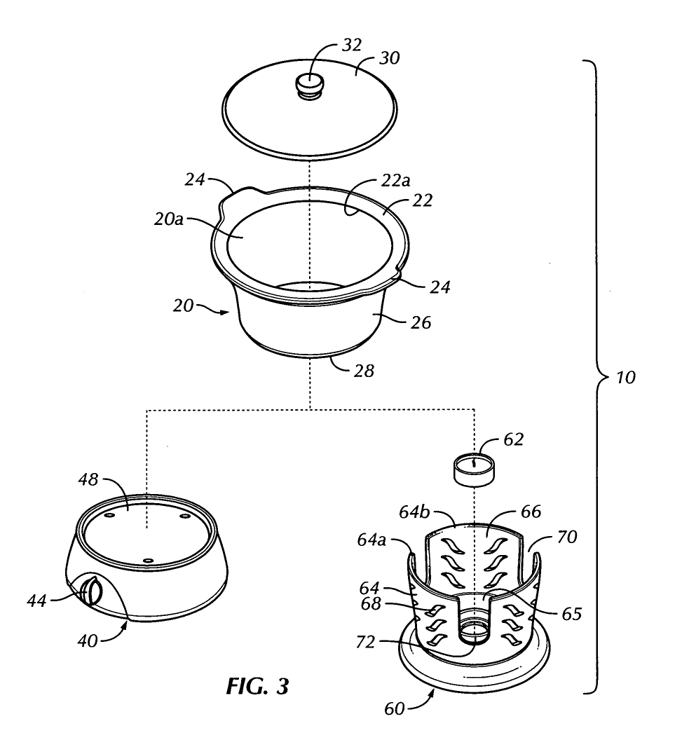

Referring to FIG. 3, the container 20 of the slow cooker 10 is intended to be used with either one of two separate warming bases, an electric, first base 40 an a non-electric, second base 60. Referring initially to FIGS. 1, 3, and 4, the first base 40 is preferably configured to support the container 20 and selectively transfer heat thereto. The first base 40 preferably has an electric heating element 42 disposed proximate a top surface 48 of the first base 40 and preferably just underneath the top surface 48. The heating element 42 warms the top surface 48 when electrically energized in order to heat the container 20 and the contents thereof when placed on the top surface 48 of the first base 40. The heating element 42 is preferably a mica-type resistive heating element, as is commonly used in the art. Because such mica-type heaters are well-known to those skilled in the art, further description thereof is omitted for purposes of convenience only and is not limiting. While the use of mica-type heaters is preferred, it is not intended to be limiting. As such, it is within the spirit and scope of the present invention that other types of heating elements be used, such as, but not limited to, calrod-type heaters.

The heating element 42 is selectively powered to heat the container 20 and the food stuffs within the interior 20a. Specifically, the first base 40 includes a user control, preferably a knob 44, and a switch 46 for controlling the temperature of the heating element 42. Preferably, the switch 46 is electrically coupled to an electrical power source (not shown) such as, for instance, a wall outlet (not shown). The knob 44 is capable of actuation by the user to control the switch 46 and, in turn, the temperature of the heating element 42. The knob 44 is preferably readily accessible to the user, preferably extending from a front surface of the first base 40. The knob 44 is preferably rotatable between an off position and at least one on position. More preferably, the knob 44 is rotatable between multiple on positions corresponding to at least a low and a high temperature setting of the switch 46. While the use of the switch 46 is preferred, it is not intended to be limiting. As such, it is within the spirit and scope of the present invention that other types of controllers be used, such as, but not limited to, a thermostat.

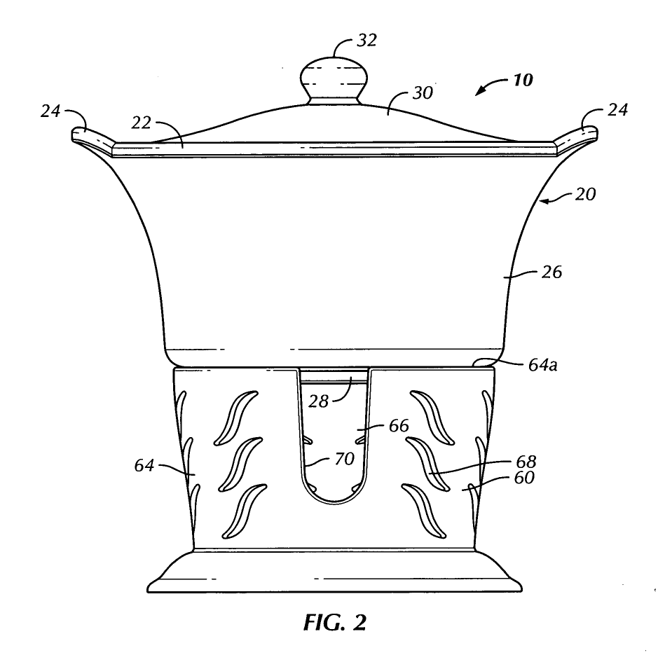

Referring now to FIGS. 2, 3, and 5, the second base 60 is configured to selectively support the container 20. The second base 60 accommodates a flame heater, such as a candle, or, more specifically, a tea light candle 62, therein for heating the container 20 and the food stuffs therein. The second base 60 preferably includes a generally cylindrical side wall 64 defining a generally hollow interior 66 for housing the flame heater 62 therein. The second base 60 preferably includes a generally flat bottom wall 65 with the side wall 64 extending upwardly therefrom and terminating at a first edge 64a. The first edge 64a defines a generally circular opening 64b for accessing the hollow interior 66 of the second base 60.

The side wall 64 of the second base 60 preferably includes a plurality of vents 68 therein. The vents 68 perform the dual function of allowing air to access the flame heater 62 within the second base 60 while, at the same time, providing an aesthetically pleasing appearance of the second base 60. The side wall 64 further includes at least one cutout 70 therein for physically accessing and/or attending to the flame heater 62. The at least one generally U-shaped cutout 70 also functions to allow air to access the interior 66 of the second base 60 to fuel the flame heater 62. Preferably, the side wall 64 includes three generally elongate cutouts 70 equidistantly spaced therearound and extending from the first edge 64a downwardly and terminating proximate the bottom wall 65. While three cutouts 70 shaped in the manner described above are preferred, it is within the spirit and scope of the present invention that there be more or less than three cutouts or no cutouts in the side wall 64 of the second base 60 or that the cutouts 70 be differently shaped, provided the second base 60 is still capable of functioning as described herein.

Preferably, the second base 60 includes a platform 72 within the hollow interior 66 thereof for supporting the flame heater 62 within the second base 60. Preferably, the platform 72 is a generally annular ring extending upwardly from the bottom wall 65 and is generally centrally located (i.e., generally equidistantly spaced from the side wall 64) on the bottom wall 65. Because the second base 60, as presently contemplated, is intended to be used only with a tea light candle 62, the platform 72 is preferably sized and shaped to accommodate a tea light candle 62. While it is preferred that only a tea light candle 62 be used within the second base 60, it is within the spirit and scope of the present invention that other flame heaters be used within the second base 60, such as candles other than tea light candles or chafing fuel cans such as Sterno® cans. While the above-described platform 72 is currently preferred, it should be evident to those skilled in the art that alternatively configured platforms be used within the second base 60 of the slow cooker 10. As such, the present invention is not limited to the platform 72 described above. For instance, it is within the spirit and scope of the present invention that the platform provide a raised stage on which to place the flame heater 62 if it is desirable to have the flame heater 62 closer to the bottom wall 28 of the container 20 when the container 20 is placed on the second base 60. Moreover, it is further contemplated that the second base 60 need not include any platform if exact placement of the flame heater 62 within the second base 60 is deemed unimportant.

While it is contemplated that other flame heaters 62 be could used within the second base 60, it is further contemplated that it may be desirable to inhibit the use of such alternative flame heaters, such as Sterno® cans, for instance, from being used within the second base 60. As such, the second base 60 could further include at least one protrusion 74 extending within the hollow interior 66 thereof to inhibit flame heaters other than tea light candles 62 from being used within the second base 60. Preferably, the second base 60 would include two or more protrusions 74 diametrically opposed from one another and disposed just outside an outer edge of the platform 72. By providing the second base 60 with such protrusions 74, alternative flame heaters such as Sterno® cans can be inhibited from being maintained in an upright position within the second base 60. While a tea light candle 62 can be placed within the platform 72 of the second base 60 without interference from the protrusions 74, because an alternative flame heater such as a Sterno® can is larger in diameter than a tea light candle, it will not fit within the annular ring of the platform 72 and necessarily will abut at least one of the protrusions 74 to cause the alternative flame heater to tilt within the hollow interior 66 of the second base 60. In this way, the alternative flame heater is inhibited from lying flat on the bottom wall 65 of the second base 60 and is rendered unfit for use in heating the container 20 placed on the second base 60.

However, should it be determined that alternative flame heaters such as Sterno® cans be desirable to use within the second base 60, the platform 72 can be enlarged and the protrusions 74 moved outwardly or removed from within the hollow interior 66 to enable a Sterno® can to be used within the second base 60. Regardless of the flame heater 62 used within the second base, the container 20 is selectively placed on the first edge 64a of the side wall 64 to be positioned sufficiently proximate the flame heater 62 for heating of the container 20 and the food stuffs therein.

Referring specifically to FIGS. 1-3, the first and second bases 40, 60 are alternatively used to heat the container 20. That is, the container 20 is capable of being placed on and supported by either of the first and second bases 40, 60. Preferably, the first base 40 and at least a portion of the container 20 are complementarily shaped so that the container 20 can be seated on and supported by the first base 40. Specifically, it is preferable that the bottom wall 28 of the container 20 and the top surface 48 of the first base 40 are complementarily shaped so that the container 20 fits on the first base 40, as shown in FIG. 1. Moreover, the second base 60 and at least the portion of the container 20, namely the bottom wall 28, are complementarily shaped so that the container 20 can be seated on and supported by the second base 60. Specifically, the bottom wall 28 of the container 20 and the first edge 64a of the side wall 64 are complementarily shaped so that the container 20 can be seated upon the second base 60, as shown in FIG. 2. In this way, the container 20 and the food stuffs therein can either be electrically heated using the first base 40 or, alternatively, heated using a tea light candle 62 with the second base 60. Preferably, the first base 40 can be used either at a low heat setting for warming of the container 20 or at a high heat setting for cooking of the food stuffs within the container 20, and the second base 60, having a tea light candle 62 therein, can be used for warming of the container 20.

In use, an appetizer or some other small-portion food stuffs can be placed within the interior 20a of the container 20. Then, depending upon the heating intensity desired and the environment in which the slow cooker 10 is to be used, either the first or the second base 40, 60 can be used to heat the container 20 and the food stuffs therein. If higher intensity cooking is desired, provided an electrical power source is located sufficiently nearby, the container 20 is placed upon the first base 40 and the knob 44 is set to the desired heat setting. If lower intensity warming is desired, the container 20 is placed upon the second base 60 with a lit flame heater 62 disposed therein. Alternatively, the first base 40 can be used to merely warm the container 20, provided the knob 44 is set to a lower heat setting. It is noted that while it is generally true that flame heaters such as tea light candles produce heat that is generally of a lower intensity, sometimes the heat from the tea light candle can be very intense, particularly at a center of the bottom wall 28 of the container 20.

The slow cooker 10 of the present invention makes possible the heating of food stuffs with or without a nearby electrical power source by providing separate first and second bases 40, 60 for heating food stuffs within the container 20 either electrically with the first base 40 or using a flame heater 62 with the second base 60. In this way, the slow cooker 10 can be used indoors or outdoors without the necessity of being proximate an electrical power source.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention as defined by the appended claims.

We claim:

1. A slow cooker for heating of food stuffs, the slow cooker comprising:
a container having a generally hollow interior and a container rim defining an opening for accessing the interior, the interior being capable of retaining the food stuffs therein;
a first base for supporting the container, the first base having an electric heating element, which is selectively powered to heat the container and the food stuffs therein; and
a second base for supporting the container, the second base accommodating a flame heater therein for heating the container and the food stuffs therein, wherein the first and second bases are alternatively used to heat the container.

2. The slow cooker of claim 1, wherein the flame heater is a candle.

3. The slow cooker of claim 1, wherein the first base includes a user control and a switch for controlling the temperature of the heating element.

4. The slow cooker of claim 3, wherein the user control is a knob.

5. The slow cooker of claim 1, wherein the second base has a side wall defining a generally hollow interior for housing the flame heater therein, the side wall having a first edge defining an opening for accessing the hollow interior of the second base, the container being selectively placed on the first edge of the side wall to be positioned sufficiently proximate the flame heater for heating of the container.

6. The slow cooker of claim 5, wherein the side wall of the second base includes a plurality of vents therein.

7. The slow cooker of claim 6, wherein the side wall of the second base further includes at least one cutout therein for accessing the flame heater.

8. The slow cooker of claim 5, wherein the second base includes a platform within the hollow interior thereof for supporting the flame heater within the second base.

9. The slow cooker of claim 8, wherein the flame heater is a tea light candle, the platform being sized and shaped to accommodate only a tea light candle.

10. The slow cooker of claim 9, wherein the second base includes at least one protrusion extending within the hollow interior thereof to inhibit flame heaters other than tea light candles from being used within the second base.

11. The slow cooker of claim 10, wherein the second base includes at least two protrusions.

12. The slow cooker of claim 1, further comprising a lid removably mounted on the container rim, the lid being sized and shaped to at least partially close the opening of the container.

13. The slow cooker of claim 1, wherein the first base and at least a portion of the container are complementarily shaped so that the container can be seated on and supported by the first base.

14. The slow cooker of claim 13, wherein the second base and at least the portion of the container are complementarily shaped so that the container can be seated on and supported by the second base.

15. The slow cooker of claim 1, wherein the second base and at least a portion of the container are complementarily shaped so that the container can be seated on and supported by the second base.

16. The slow cooker of claim 15, wherein the second base has a side wall having a first edge, the portion of the container and the first edge being complementarily shaped.

17. The slow cooker of claim 1, wherein the second base includes at least one protrusion therein to inhibit flame heaters other than tea light candles from being used within the second base.

18. The slow cooker of claim 17, wherein the second base includes at least two protrusions.
